(19) United States
(12) Patent Application Publication
(10) Pub. No.: US 2003/0179180 A1
(43) Pub. Date: Sep. 25, 2003

(54) Coordinates inputting apparatus

(75) Inventor: Junichi Inamura, Fukushima-ken (JP)

Correspondence Address: Brinks Hofer Gilson & Lione, P.O. Box 10395, Chicago, IL, 60610, US

(73) Assignee: Alps Electric Co., Ltd.

(21) Appl. No.: 10/392,161

(22) Filed: Mar. 19, 2003

(30) Foreign Application Priority Data
Mar. 22, 2002 (JP) 2002-080657

(51) Int. Cl. G09G 5/00

(52) U.S. Cl. 345/156

(57) ABSTRACT

A coordinates inputting apparatus of the invention includes input means having an operation surface capable of inputting desired coordinates and a base plate for placing the input means, wherein a cushion layer is defined between the base plate and the input means. Therefore, when the operation surface is operated with a fingertip, for example, the cushion layer can improve feel transmitted to the fingertip. Consequently, a coordinates inputting apparatus having high operation performance can be provided.

### BACKGROUND OF THE INVENTION

1. Field of the Invention

This invention relates to a coordinates inputting apparatus. The invention relates, for example, to a coordinates inputting apparatus used as a pointing device of a notebook type personal computer (“notebook personal computer”).

2. Description of the Related Art

A known coordinates inputting apparatus 21 will be explained with reference to FIG. 6 that is a sectional view of principal portions. The coordinates inputting apparatus 21 is a kind of pointing devices mounted to a notebook personal computer, etc, and can input coordinates by varying an electrostatic capacity.

The known coordinates inputting apparatus 21 includes a face sheet 22 of an insulating film at its uppermost portion and input means 23 arranged below the face sheet 22. The input means 23 has a film substrate 23a formed of a dielectric film having a predetermined thickness. A plurality of X electrodes (not shown in the drawing) is formed into a linear pattern and extends on an upper surface of the film substrate 23a. A plurality of Y electrodes (not shown) extends in a pattern shape on the back of the film substrate 23a in a direction crossing the X electrodes. These X and Y electrodes are arranged in a matrix shape.

The film substrate 23 having the X and Y electrodes on both surfaces thereof is put on a base plate 25 formed of a rigid material such as a metal sheet through an insulating film 24 and is fitted to a notebook personal computer (not shown), etc.

When a fingertip, or the like, positioned on the face sheet 22 is moved along the surface of the face sheet 22 in the known coordinates inputting apparatus 21, the electrostatic capacity between the X electrode and the Y electrode varies with the movement of the fingertip through the film substrate 23.

When control means (not shown) detects this change of the electrostatic capacity, an image, etc, on a display of the notebook personal computer can be moved (dragged) to a desired position.

When an operator gently taps the operation surface with the fingertip, the image dragged to the desired position can be determined.

In the known coordinates inputting apparatus 21, however, the input means 23 is put on the hard base plate through the insulating film 24. Therefore, when the operator moves the fingertip positioned on the face sheet 22, the feel the operator acquires through the fingertip gets deteriorated.

When the operator gently taps the operation surface with the fingertip, too, the operator gets an offensive feel because the hardness of the base plate 25 is transmitted to the fingertip.

In view of these problems, the invention aims at providing a coordinates inputting apparatus capable of improving feel transmitted to a fingertip when an operator inputs coordinates with the fingertip.

### SUMMARY OF THE INVENTION

AS first resolution means for solving the problems, the invention provides a coordinates inputting apparatus including input means having an operation surface capable of inputting desired coordinates and a base plate for placing the input means, wherein a cushion layer is formed between the base plate and the input means.

As second resolution means for solving the problems, the invention provides a coordinates inputting apparatus described above, wherein the input means comprises one of electrodes and the other electrode formed on a side opposite to one of the electrodes with a predetermined spacing between them.

AS third resolution means for solving the problems, the invention provides a coordinates inputting apparatus described above, wherein an insulating member formed of a dielectric film having a predetermined thickness is arranged in the spacing, and an operation member positioned on the operation surface is moved along the operation surface to thereby change an electrostatic capacity between one and the other of the electrodes.

As fourth resolution means for solving the problems, the invention provides a coordinates inputting apparatus described above, wherein a switch device is arranged below the cushion layer, and can be switched through the cushion layer when an arbitrary position of the operation surface is pushed by the operation member.

As fifth resolution means for solving the problems, the invention provides a coordinates inputting apparatus described above, wherein the switch device includes a lower substrate having a fixed contact film formed on a surface thereof and an upper substrate having a movable contact film on a side opposite to the fixed contact film, and a spacing having a predetermined size is defined between the fixed contact film and the movable contact film.

The invention further employs the construction wherein the surface of the lower substrate having the fixed contact film formed thereon is allowed to protrude to a predetermined height in such a fashion as to define a plurality of insulating protuberances, and the insulating protuberances insulate the fixed contact film from the movable contact film.

### BRIEF DESCRIPTION OF THE DRAWINGS

FIG. 1 is a sectional view of principal portions of a coordinates inputting apparatus according to the invention;

FIG. 2 is an exploded perspective view of input means according to the invention;

FIG. 3 is a sectional view of principal portions of a switch device according to the invention;

FIG. 4 is a perspective view of an appearance of a notebook personal computer according to the invention;

FIG. 5 is a sectional view of principal portions of input means according to another embodiment of the invention; and

FIG. 6 is a sectional view of principal portions of a coordinates inputting apparatus according to the prior art.

### DESCRIPTION OF THE PREFERRED EMBODIMENTS

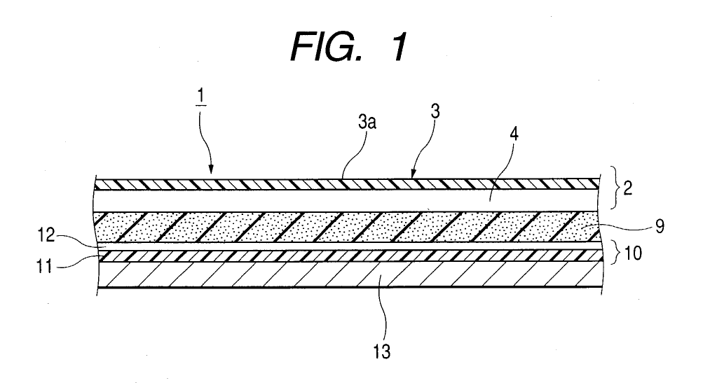

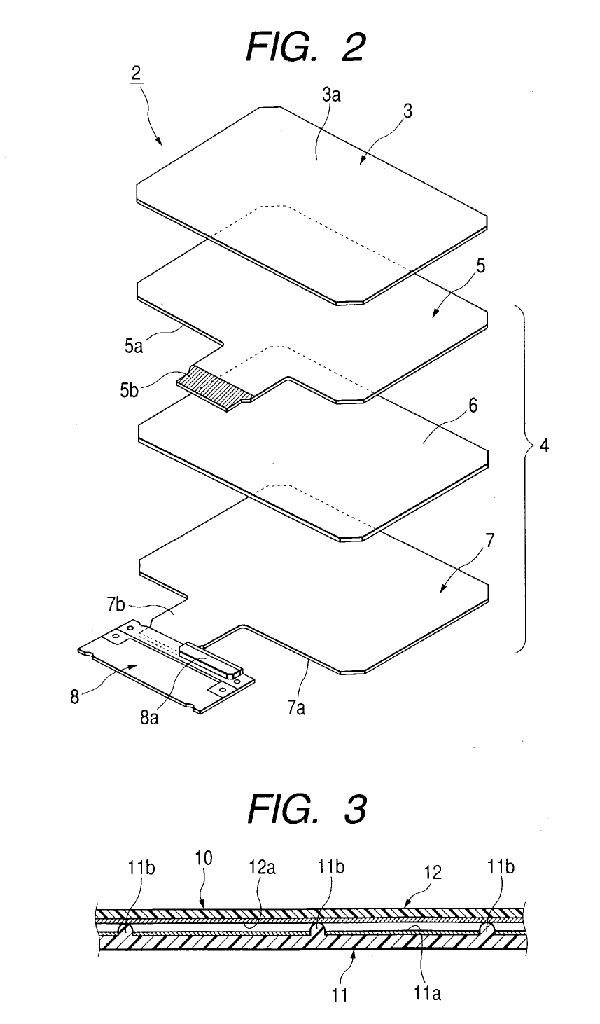

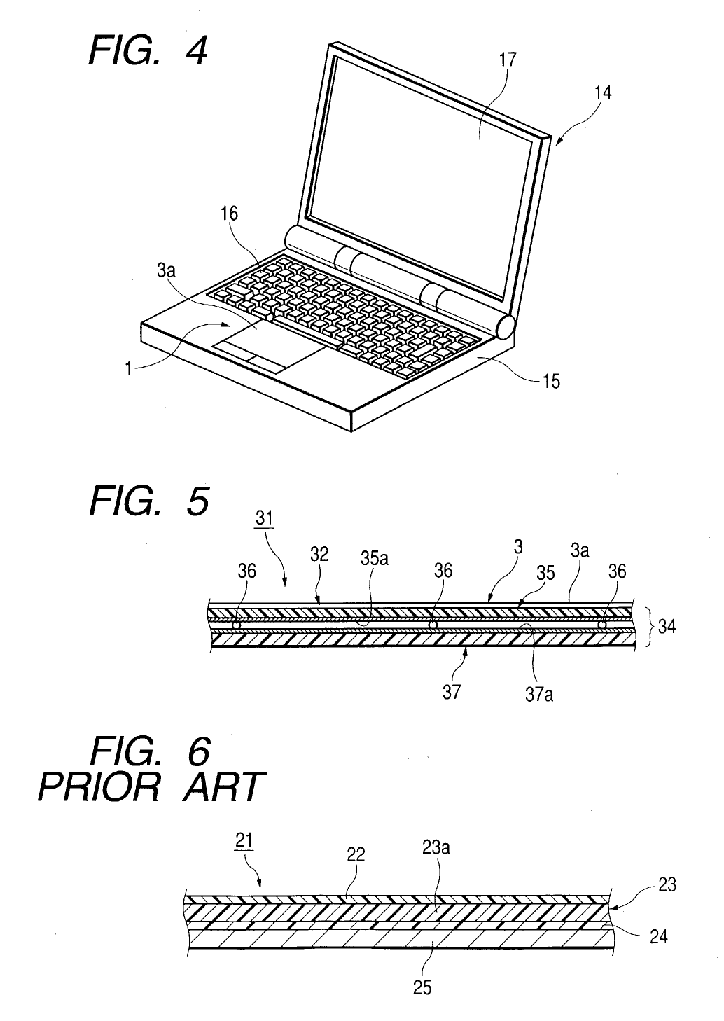

Coordinates inputting apparatuses according to preferred embodiments of the invention will be hereinafter explained with reference to the accompanying drawings. FIG. 1 is a sectional view of principal portions of a coordinates inputting apparatus according to the invention. FIG. 2 is an exploded perspective view of input means according to the invention. FIG. 3 is a sectional view of principal portions of a switch device according to the invention. FIG. 4 is a perspective view of an appearance of a notebook personal computer according to the invention. FIG. 5 is a sectional view of principal portions of input means according to another embodiment of the invention.

Referring initially to FIG. 1, the coordinates inputting apparatus 1 according to the invention includes input means 2 at its upper portion. The input means 2 includes a face sheet 3 formed of an insulating film at its uppermost portion as shown in FIG. 2. The face sheet 3 has on its surface an operation surface 3a of an overcoat surface having wear resistance.

An input portion 4 is arranged below the face sheet 3. The input portion 4 has a laminate structure of an upper film substrate 5, an insulating member 6 and a lower film substrate 7 that are stacked from above in order named.

The upper film substrate 5 uses a transparent synthetic resin film having a thickness of about 0.2 mm such as PET (polyethylene terephthalate).

The upper film substrate 5 is shaped into a substantial rectangular shape and a part of its side 5a on the left side in the drawing protrudes sideward to form a terminal portion 5b.

One of electrodes (not shown in the drawing) having a plurality of driving electrode patterns, for example, is so formed on the back of the upper film substrate 5 as to linearly extend in an X direction.

One of the electrodes formed of a plurality of driving electrode patterns is extend up to the terminal portion 5b.

The insulating member 6 formed of a dielectric film having a predetermined thickness is arranged below the upper film substrate 5. The insulating member 6 is formed of a PET film, and an adhesive (not shown) is applied to upper and lower surfaces of the PET film.

The lower film substrate 7 having a thickness of about 0.2 mm is arranged below the insulating member 6. The lower film substrate 7 is formed of a synthetic resin film having an insulating property such as PET in the same way as the upper film substrate 5.

The lower film substrate 7 is shaped into a substantial rectangular shape having the same size as that of the upper film substrate 5 and a part of its side 7a on the left side in the drawing protrudes sideward to form a terminal portion 7b.

The other electrode (not shown) linearly extending in a Y direction that crosses one of the electrodes is formed on the surface of the lower film substrate 7 opposing the insulating member 6.

In other words, one and the other of the electrodes are formed in a matrix shape in such a manner as to oppose each other through the insulating member 6 and to form a predetermine electrostatic capacity between them.

Therefore, when an operation member such as a fingertip positioned on the operation surface 3a of the face sheet 3 is moved along the operation surface 3a, the electrostatic capacity between one and the other of the electrodes is varied.

A control circuit substrate 8 is arranged at a distal end of the terminal portion 7d of the lower film substrate 7. The terminal portions 5b and 7b of the upper and lower film substrates 5 and 7 are respectively connected to the control circuit substrate 8. A controller 8a such as an ROM is mounted to the control circuit substrate 8.

A cushion layer 9 having a predetermined thickness is arranged at a lower portion of the input means 2 as shown in FIG. 1. The cushion layer 9 is formed of rubber having flexibility or sponge. When the operation surface 3a is pushed with a fingertip as the operation member, the cushion layer 9 at this pushed portion undergoes elastic deformation through the input portion 4 and an operator can feel a stroke at the fingertip.

The switch device 10 is arranged below the cushion layer 9. A lower substrate 11 formed of a plastic material is arranged below the switch device 10 as shown in FIG. 3, and an electrically conductive fixed contact film 11a is formed to a predetermined thickness on the surface of this lower substrate 11.

The surface side of the lower substrate 11 having the fixed contact film 11a is allowed to partially protrude to a predetermined height, thereby forming a plurality of insulating protuberances 11b.

These insulating protuberances 11b are formed simultaneously with shaping of the lower substrate 11.

A resistor material made of an electrically conductive material is sputtered and vacuum deposited, for example, from the side of the surface having the insulating protuberances 11b to form the fixed contact film 11a on the surface of the top of the insulating protuberances 11b and on the surface of the lower substrate 11.

Sputtering and vacuum deposition of the fixed contact film 11a is carried out in such a fashion that the fixed contact film 11a is not formed on the sidewalls of the insulating protuberances 11b that are substantially erected from the lower substrate 11.

The upper substrate 12 is arranged over the insulating protuberances 11b of the lower substrate 11.

A movable contact film 12a formed of the same material as that of the fixed contact film 11a is formed on the surface of the upper substrate 12 that opposes the fixed contact film 11a.

The insulating protuberances 11b create gaps of a predetermined size between the fixed contact film 11a and the movable contact film 12a.

The switch device 10 is mounted to a base plate 13 formed of a metal sheet.

The coordinates inputting apparatus 1 according to the invention is mounted to a notebook personal computer 14 shown in FIG. 4.

The notebook personal computer 14 primarily includes a main body case 15, the coordinates inputting apparatus 1 of the invention assembled into the main body case 15, a keyboard 16 including a plurality of key switches and a display 17 such as a liquid crystal display.

When the finger of the operator as the operation member is positioned on the operation surface 3a of the coordinates inputting apparatus 1 assembled into the main body case 15 and is slid along the operation surface 3a, the electrostatic capacity between one and the other of the electrodes changes in accordance with the movement of the fingertip.

The controller 8a detects the change of the electrostatic capacity, and can thus move (drag) an image displayed on the display 17 to a desired position.

The feel of touch the operator acquires through the fingertip during this dragging operation of the image becomes soft due to the cushion layer 9 arranged below the input means 2, and the operation factor of the coordinates inputting apparatus 1 can be improved.

After the image is dragged to the desired position, an arbitrary position of the operation surface 3a is pushed with the fingertip. In consequence, the movable contact film 12a is pushed and lowered through the cushion layer 9.

As the movable contact film 12a comes into contact with, and is electrically connected to, the fixed contact film 11a, the switching device 10 is switched and the image dragged to the desired position is determined.

When the push operation of the operation surface 3a is made, the cushion layer 9 undergoes elastic deformation, and the operator can acquire the same feel of stroke through the fingertip pushing the operation surface 3a as the feel the operator acquires when operating the key switches of the keyboard 16.

Therefore, operation feeling can be improved at the time of switching of the switch device 10.

This embodiment represents the case where the input means 2 detects the change of the electrostatic capacity between the two electrodes and inputs the coordinates. In another embodiment of the invention, however, a coordinates inputting apparatus 31 may use tablet type input means 32 as shown in FIG. 5.

The input means 32 includes a face sheet 3 arranged at the uppermost portion and a tablet type input portion 34 arranged below the face sheet 3.

The tablet type input means 34 includes an upper film substrate 35, an insulating member 36 and a lower film substrate 37. The upper film substrate 35 has on its lower surface one of electrodes 35a formed of an ITO film.

The insulating member 36 is formed of a plurality of insulating particles having a predetermined particle diameter. The lower film substrate 37 has the other electrode 37a of the ITO film on the surface side opposing one of the electrodes 35a. A plurality of insulating members 36 each formed of the insulating particles is bonded onto the other electrode 37a through an adhesive (not shown).

In other words, the input means 32 in another embodiment of the invention includes one of the electrodes 35a and the other electrode 37a formed on the opposite side to this one electrode 35a through the insulating member 36.

The cushion layer 9 and the switch device 10 are arranged below the input means 32.

When the operator gently pushes with the fingertip the operation surface 3a in the coordinates inputting apparatus 31 according to another embodiment, one of the electrodes 35a of the pushed portion lowers, comes into contact with the other electrode 37a and establishes electric connection.

Then, the operator can move the cursor of the display 17 of the notebook personal computer 17 to a desired position.

As described above, the coordinates inputting apparatus according to the invention includes the cushion layer formed between the base plate and the input means. Therefore, the coordinates inputting apparatus can improve operation feel transmitted to the fingertip when the operator moves the fingertip as the operation member along the operation surface of the input means when inputting the coordinates.

When the operation surface is pushed, the cushion layer undergoes elastic deformation, thereby providing feel of stroke to the fingertip of the operator. Therefore, the invention can achieve the coordinates inputting apparatus having high operation performance.

The input means includes one of the electrodes and the other electrode formed on the opposite side to the former with a predetermined spacing between them. Therefore, the operator can easily vary the electrostatic capacitance formed between one and the other of the electrodes by bringing the fingertip close to the electrodes and can input the coordinates.

Alternatively, the operator can input highly precisely the coordinates by pushing the operation surface to electrically connect one of the electrodes to the other.

The insulating member formed of the dielectric film having a predetermined thickness is arranged in the spacing. When the operation member such as the fingertip put on the operation surface is moved along the operation surface, the electrostatic capacity between one and the other of the electrodes varies. Therefore, the change amount of the electrostatic capacity can be increased and a high precision coordinates inputting operation can be made.

The switch device is arranged below the cushion layer so that it can be switched through the cushion layer when the operator pushes an arbitrary position of the operation surface with the operation member. As the cushion layer undergoes elastic deformation when the operation surface is pushed, the operator can acquire feel of stroke through the fingertip.

The switch device includes the lower substrate having the fixed contact film formed on its surface and the upper substrate having the movable contact film on the opposite side to the fixed contact film, and the spacing having a predetermined size is defined between the fixed contact film and the movable contact film. Therefore, the invention can provide the coordinates inputting apparatus in which the switching operation is easy.

The surface side of the lower substrate on which the fixed contact film is formed is allowed to protrude to a predetermined height in such a fashion as to define a plurality of insulating protuberances that insulate the fixed contact film from the movable contact film. Therefore, the switching operation is easy, and the insulating protuberances can reliably insulate the fixed contact film from the movable contact film even when external vibration, etc, is transmitted.

1. A coordinates inputting apparatus including input means having an operation surface capable of inputting desired coordinates and a base plate for placing said input means, wherein a cushion layer is formed between said base plate and said input means.

2. A coordinates inputting apparatus according to claim 1, wherein said input means comprises one of electrodes and the other electrode formed on a side opposite to said one electrode with a predetermined spacing between them.

3. A coordinates inputting apparatus according to claim 2, wherein an insulating member formed of a dielectric film having a predetermined thickness is arranged in said spacing, and an operation member positioned on said operation surface is moved along said operation surface to thereby change an electrostatic capacity between said one and the other of said electrodes.

4. A coordinates inputting apparatus according to claim 1, wherein a switch device is arranged beneath said cushion layer, and can be switched through said cushion layer when an arbitrary position of said operation surface is pushed by said operation member.

5. A coordinates inputting apparatus according to claim 4, wherein said switch device includes a lower substrate having a fixed contact film formed on a surface thereof and an upper substrate having a movable contact film on a side opposite to said fixed contact film, and a spacing having a predetermined size is defined between said fixed contact film and said movable contact film.

6. A coordinates inputting apparatus according to claim 5, wherein the surface side of said lower substrate having said fixed contact film formed thereon is allowed to protrude to a predetermined height in such a fashion as to define a plurality of insulating protuberances, and said insulating protuberances insulate said fixed contact film from said movable contact film.
